(19) United States
(12) Patent Application Publication
(10) Pub. No.: US 2025/0196903 A1
(43) Pub. Date: Jun. 19, 2025

(54) ADJUSTABLE AND DETACHABLE CLOTH BAG TROLLEY WITH SWIVEL CASTERS

(71) Applicant: ZHEJIANG NAST DAILY NECESSITIES CO., LTD, JIAXING (CN)

(72) Inventors: YUNHUA PENG, JIAXING (CN); ZIYING WU, JIAXING (CN)

(21) Appl. No.: 18/433,603

(22) Filed: Feb. 6, 2024

(30) Foreign Application Priority Data
Dec. 15, 2023 (CN) 202323429555.1

(51) Int. Cl. B62B 3/02; B62B 3/10; B62B 5/06

(52) U.S. Cl. CPC B62B 3/022; B62B 3/106; B62B 5/064; B62B 2205/06; B62B 2301/044

(57) ABSTRACT

Disclosed is an adjustable and detachable cloth bag trolley with swivel casters, including: a base brace, support braces and roller assemblies. The base brace includes a rotary pedestal and bottom support rods. The support braces each include a first support rod and a second support rod. The first support rod includes a fixed rod and an adjusting rod. The adjusting rod is slidably arranged in the fixed rod and provided with a plurality of adjusting holes at a lower end thereof. An upper end of the fixed rod is provided with a through-type locking hole, and a locking bolt is inserted into the locking hole. The roller assemblies each include a mounting sleeve and a swivel caster. The mounting sleeve is inserted into a lower end of the support brace, and the swivel caster is rotatably arranged at a lower end of the mounting sleeve.

### TECHNICAL FIELD

The present disclosure relates to the technical field of storage and transportation, and in particular to an adjustable and detachable cloth bag trolley with swivel casters.

### BACKGROUND

Cloth bag trolleys are a common tool for people's daily life, especially in supermarkets which are almost always equipped with cloth bag trolleys. Many families also have cloth bag trolleys for shopping or camping. However, a conventional cloth bag trolley has a welded and fixed brace which is non-detachable, and thus, occupies a large space, making it inconvenient for transportation and storage. Moreover, the size of the cloth bag trolley is fixed and unadjustable, making the cloth bag trolley low in applicability.

### SUMMARY

In order to solve the problems in the prior art, the present disclosure provides an adjustable and detachable cloth bag trolley with swivel casters.

The objective of the present disclosure may be realized by the following technical solution: an adjustable and detachable cloth bag trolley with swivel casters includes: a base brace, support braces and roller assemblies. The base brace includes a rotary pedestal and bottom support rods. One end of each of the bottom support rods is rotatably arranged on the rotary pedestal, and an other end is rotatably connected with the support brace. The support braces each include a first support rod and a second support rod that are rotatably connected. The first support rod includes a fixed rod and an adjusting rod. The adjusting rod is slidably arranged in the fixed rod and provided with a plurality of adjusting holes at a lower end thereof. An upper end of the fixed rod is provided with a through-type locking hole, and a locking bolt is inserted into the locking hole. The roller assemblies each include a mounting sleeve and a swivel caster. The mounting sleeve is inserted into a lower end of the support brace, and the swivel caster is rotatably arranged at a lower end of the mounting sleeve.

As a further improvement, the adjustable and detachable cloth bag trolley with swivel casters further includes a lateral support brace. The lateral support brace is rotatably connected with the support braces.

As a further improvement, an upper end of each of the adjusting rods is provided with a handle assembly, and the handle assembly includes a rotating seat and a push handle. The rotating seat is fixedly arranged on the upper end of the adjusting rod, and a lower end of the push handle is rotatably arranged in the rotating seat.

As a further improvement, the rotating seat is provided with a through-type limit sliding slot, and a limit assembly is slidably arranged in the limit sliding slot. The limit assembly includes a limit rod, and the limit rod is slidably arranged in the limit sliding slot and threadedly connected with a limit nut at a tail end thereof.

As a further improvement, the mounting sleeve is mounted to the lower end of the support brace through a bolt.

Compared with the prior art, the present disclosure has the following beneficial effects:
1. When the present disclosure is in use, the base brace is pressed down, so that the bottom support rods rotate outwards. During the rotation of the bottom support rods, the support braces are driven to be unfolded and restored into an in-use state. When the present disclosure needs to be folded, the first support rods and the second support rods are pushed inwards. While the first support rods and the second support rods are moving inwards, the bottom support rods are driven to rotate inwards, so that the base brace and the support braces are folded together, thereby reducing the space required for storage and being convenient to store and carry.
2. In the present disclosure, the adjusting rod is slidably arranged in the fixed rod, so that the extension of the adjusting rod can be adjusted according to the actual situation during use, so as to meet the use requirements of different people.

### BRIEF DESCRIPTION OF FIGURES

FIG. 1 is a schematic structural view of the present disclosure;

FIG. 2 is a schematic local structural view of the present disclosure; and

FIG. 3 is a schematic structural view of a first support rod and a handle assembly of the present disclosure.

In the figures: 1, base brace; 11, rotary pedestal; 12, bottom support rod; 2, support brace; 21, first support rod; 211, fixed rod; 2111, locking hole; 212, adjusting rod; 2121, adjusting hole; 213, locking bolt; 22, second support rod; 3, roller assembly; 31, mounting sleeve; 32, swivel caster; 4, lateral support brace; 5, handle assembly; 51, rotating seat; 511, limit sliding slot; 512, limit assembly; 5121, limit rod; 5122, limit nut; and 52, push handle.

### DETAILED DESCRIPTION

In the description of the present disclosure, it should be noted that the orientation or positional relationship indicated by the terms “central”, “upper”, “lower”, “left”, “right”, “vertical”, “horizontal”, “inner”, “outer” or the like is based on the orientation or positional relationship shown in the accompanying drawings. This is only for the convenience of describing the present disclosure and simplifying the description, and does not indicate or imply that the device or element must have a specific orientation, or be constructed and operated in a specific orientation, and therefore cannot be understood as a limitation of the present disclosure.

In the description of the present disclosure, it should be noted that unless otherwise clearly specified and defined, the term “mounted”, “linked” or “connected” should be understood in a broad sense. For example, it may be a fixed connection, a detachable connection or an integral connection. For those of ordinary skill in the art, the specific meaning of the above terms in the present disclosure may be understood in the light of specific situations.

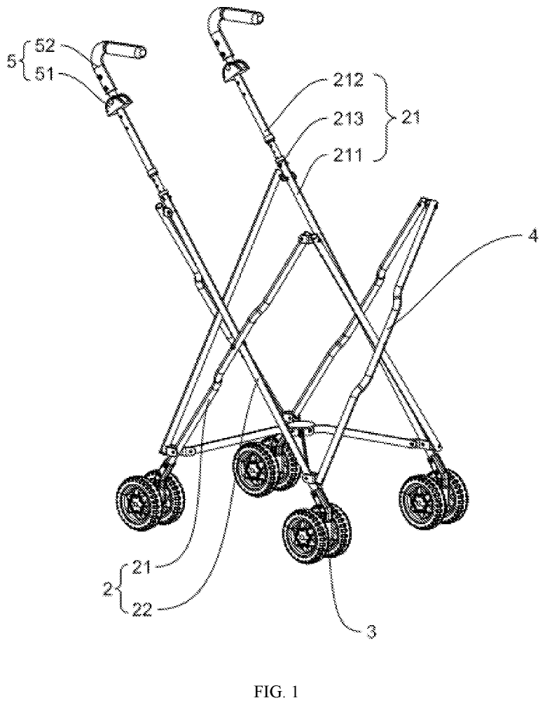

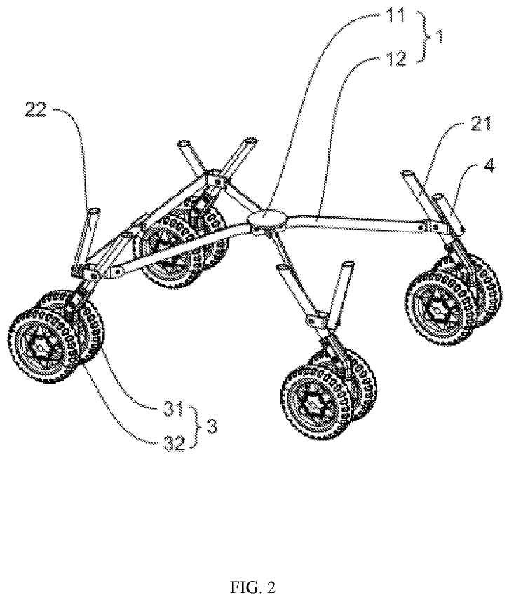

The technical solution of the present disclosure will be further described below in conjunction with the embodiment and FIG. 1 to FIG. 3.

### Embodiment 1

An adjustable and detachable cloth bag trolley with swivel casters includes: a base brace 1, support braces 2 and roller assemblies 3. The base brace 1 includes a rotary pedestal 11 and bottom support rods 12. One end of each of the bottom support rods 12 is rotatably arranged on the rotary pedestal 11, and an other end is rotatably connected with the support brace 2. The support braces 2 each include a first support rod 21 and a second support rod 22 that are rotatably connected. The first support rod 21 includes a fixed rod 211 and an adjusting rod 212. The adjusting rod 212 is slidably arranged in the fixed rod 211 and provided with a plurality of adjusting holes 2121 at a lower end thereof. An upper end of the fixed rod 211 is provided with a through-type locking hole 2111, and a locking bolt 213 is inserted into the locking hole 2111. The roller assemblies 3 each include a mounting sleeve 31 and a swivel caster 32. The mounting sleeve 31 is inserted into a lower end of the support brace 2, and the swivel caster 32 is rotatably arranged at a lower end of the mounting sleeve 31.

As shown in FIG. 1 to FIG. 3, when the present disclosure is in use, the base brace 1 is pressed down, so that the bottom support rods 12 rotate outwards. During the rotation of the bottom support rods 12, the support braces 2 are driven to be unfolded and restored into an in-use state. When the present disclosure needs to be folded, the first support rods 21 and the second support rods 22 are pushed inwards. While the first support rods 21 and the second support rods 22 are moving inwards, the bottom support rods 12 are driven to rotate inwards, so that the base brace 1 and the support braces 2 are folded together, thereby reducing the space required for storage and being convenient to store and carry.

The adjusting rod 212 is slidably arranged in the fixed rod 211, so that the extension of the adjusting rod 212 can be adjusted according to the actual situation during use, so as to meet the use requirements of different people.

As a further preferred embodiment, the adjustable and detachable cloth bag trolley with swivel casters further includes a lateral support brace 4. The lateral support brace 4 is rotatably connected with the support braces 2, thereby further improving the overall strength of the trolley.

As a further preferred embodiment, an upper end of each of the adjusting rods 212 is provided with a handle assembly 5, and the handle assembly 5 includes a rotating seat 51 and a push handle 52. The rotating seat 51 is fixedly arranged on the upper end of the adjusting rod 212, and a lower end of the push handle 52 is rotatably arranged in the rotating seat 51.

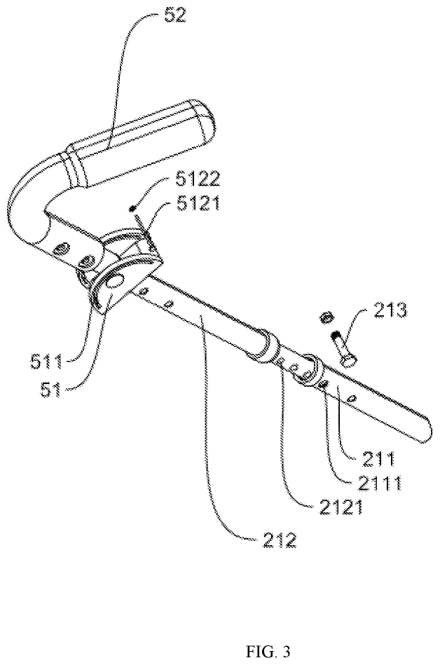

Specifically, as shown in FIG. 3, during use, the angle of rotation of the push handle 52 relative to the rotating seat 51 may be adjusted according to different use postures, so as to meet the use requirements of different people.

As a further preferred embodiment, the rotating seat 51 is provided with a through-type limit sliding slot 511, and a limit assembly 512 is slidably arranged in the limit sliding slot 511. The limit assembly 512 includes a limit rod 5121, and the limit rod 512 is slidably arranged in the limit sliding slot 511 and threadedly connected with a limit nut 5122 at a tail end thereof. After the adjustment of the push handle 52 is completed, the limit rod 5121 may limit the push handle, thereby preventing the push handle 52 from rotating during use.

As a further preferred embodiment, the mounting sleeve 31 is mounted to the lower end of the support brace 2 through a bolt, and the roller assembly 3 is sleeved and mounted on the lower end of the support brace 2 through a bolt, which is simple in structure and convenient for later maintenance and replacement.

Preferred specific embodiments of the present disclosure have been described in detail above. It should be understood that those of ordinary skill in the art can make various modifications and changes according to the concept of the present disclosure without creative work. Therefore, any technical solution that can be obtained by those skilled in the art through logical analysis, reasoning or limited experiments based on the concept of the present disclosure shall fall within the protection scope determined by the claims.

What is claimed is:

1. An adjustable and detachable cloth bag trolley with swivel casters, comprising: a base brace (1), support braces (2) and roller assemblies (3), wherein the base brace (1) comprises a rotary pedestal (11) and bottom support rods (12), one end of each of the bottom support rods (12) being rotatably arranged on the rotary pedestal (11), and an other end being rotatably connected with the support brace (2); the support braces (2) each comprise a first support rod (21) and a second support rod (22) that are rotatably connected, the first support rod (21) comprising a fixed rod (211) and an adjusting rod (212), the adjusting rod (212) being slidably arranged in the fixed rod (211) and provided with a plurality of adjusting holes (2121) at a lower end thereof, an upper end of the fixed rod (211) being provided with a through-type locking hole (2111), and a locking bolt (213) being inserted into the locking hole (2111); and the roller assemblies (3) each comprise a mounting sleeve (31) and a swivel caster (32), the mounting sleeve (31) being inserted into a lower end of the support brace (2), and the swivel caster (32) being rotatably arranged at a lower end of the mounting sleeve (31).

2. The adjustable and detachable cloth bag trolley with swivel casters according to claim 1, further comprising a lateral support brace (4), wherein the lateral support brace (4) is rotatably connected with the support braces (2).

3. The adjustable and detachable cloth bag trolley with swivel casters according to claim 1, wherein an upper end of each of the adjusting rods (212) is provided with a handle assembly (5), and the handle assembly (5) comprises a rotating seat (51) and a push handle (52), the rotating seat (51) being fixedly arranged on the upper end of the adjusting rod (212), and a lower end of the push handle (52) being rotatably arranged in the rotating seat (51).

4. The adjustable and detachable cloth bag trolley with swivel casters according to claim 3, wherein the rotating seat (51) is provided with a through-type limit sliding slot (511), and a limit assembly (512) is slidably arranged in the limit sliding slot (511); and the limit assembly (512) comprises a limit rod (5121), and the limit rod (512) is slidably arranged in the limit sliding slot (511) and threadedly connected with a limit nut (5122) at a tail end thereof.

5. The adjustable and detachable cloth bag trolley with swivel casters according to claim 1, wherein the mounting sleeve (31) is mounted to the lower end of the support brace (2) through a bolt.
